(19) United States
(12) Patent Application Publication
(10) Pub. No.: US 2024/0308886 A1
(43) Pub. Date: Sep. 19, 2024

(54) Water treatment method combining PVA gel bead and electrolysis

(71) Applicant: AquaClear Sustainable Co., Ltd., Hsinchu City (TW)

(72) Inventors: Shih-Wei Huang, Hsinchu City (TW); Sz-Chwun Hwang, Hsinchu City (TW); Z-Yu Huang, Hsinchu City (TW)

(21) Appl. No.: 18/233,903

(22) Filed: Aug. 15, 2023

Related U.S. Application Data
(60) Provisional application No. 63/397,896, filed on Aug. 15, 2022.
(60) Provisional application No. 63/411,639, filed on Sep. 30, 2022.
(60) Provisional application No. 63/414,910, filed on Oct. 11, 2022.

(51) Int. Cl. C02F 1/461

(52) U.S. Cl. CPC C02F 1/46114

(57) ABSTRACT

This invention demonstrates with practical examples that the PVA-immobilized microbial gel bead technology can protect microorganisms and can perfectly match the electrolysis that inhibits microorganisms. For instance: (1) After nitrification in the PVA gel bead system, nitrate-nitrogen can be removed through electrolysis. (2) In the case of high COD (Chemical Oxygen Demand) or organic nitrogen concentration, the PVA gel bead system can be used for degradation or hydrolysis, followed by rapid electrolytic removal of refractory COD and ammonia-nitrogen. (3) By integrating the PVA gel bead system with the electrolysis system in parallel, the rapid response of electrolysis can be utilized to swiftly adjust the overall performance of water treatment. (4) For low-salinity water body, the “PVA Gel Bead Energization” treatment can be applied, where the electrodes are directly inserted into the bioreactor. (5) As for high-salinity water body, electrolysis can be conducted first to increase the C/N ratio, facilitating subsequent COD degradation in the PVA gel bead system.

### FIELD OF THE INVENTION

The present invention relates to a following water treatment method utilizing polyvinyl alcohol (PVA) gel beads and electrolysis: (1) Nitrification of nitrogen-containing water bodies using PVA gel beads, followed by denitrification of the generated nitrate ions using electrolysis; (2) Partial degradation of organics and nitrification in water bodies with high Carbon-to-Nitrogen (C/N) ratios using PVA gel beads, followed by electrolysis to remove residual pollutants; (3) Hydrolysis of organic nitrogen using PVA gel beads and subsequent electrolysis to remove ammonia nitrogen (NH₃—N) and other pollutants; (4) For halogen-containing water bodies, initial electrolysis to remove most of the ammonia nitrogen and/or nitrate ions, followed by PVA gel beads treatment for remaining COD; (5) Parallel connection of the PVA gel bead system and the electrolysis system; activation of the electrolysis system when the biological system exhibits instability; (6) Placing PVA gel beads and an electrolysis device in the same reactor, enabling anaerobic ammonia oxidation by bacteria within the beads, leading to direct ammonia degradation without nitrate generation while maintaining biological activity.

### BACKGROUND OF THE INVENTION

The optimal treatment technique for medium to low concentration ammonia nitrogen is biological treatment. However, traditional biological treatment method requires both nitrification and denitrification processes to convert ammonia nitrogen into nitrogen gas, necessitating additional carbon sources. This method not only escalates the cost of the additional inputs but also carries the risk of elevated Chemical Oxygen Demand (COD). Anaerobic ammonium oxidation (Anammox) within biological treatment can transform ammonia nitrogen into nitrogen gas without the need for supplemental carbon sources and is considered the ideal solution for ammonia nitrogen pollution. While literature documents the utilization of Anammox bacteria in various water treatment facilities, reports also acknowledge limitations in the Anammox technology, both in pilot-scale testing and industrial-scale implementation. Factors such as temperature, pH levels, dissolved oxygen concentration, nitrogen loading, and organic content pose constraints, and the presence of certain compounds (e.g., sulfides, toxic heavy metals, alcohols, phenols, and antibiotics) might inhibit Anammox bacteria (Cho et al., 2020).

Chinese patent document CN 101693577 A (2010) proposes an electrolysis-biological anaerobic reactor, primarily involving the installation of electrolysis equipment alongside a conventional biological anaerobic reactor, specifically an Upflow Anaerobic Sludge Blanket (UASB) reactor. The concern with this electrolysis equipment is that the chlorine produced during sodium chloride electrolysis might harm the bacteria within the UASB reactor. To address this, cation ion exchange membranes are used to separate the chlorine from entering the UASB reactor. However, this leads to significant resistance, resulting in unexpectedly high operating temperature of up to 61° C. under normal current densities of 20-30 mA/cm². In the specification of the aforementioned Chinese patent document, paragraph 0022 explains the use of sulfate salts as the catholyte. In such a scenario, the sulfate salts would be reduced to sulfides, and hydrogen sulfide might be released into the air at pH below 9.3.

Chinese patent document CN 101704595 A (2010) presents a method for removing nitrates from water. The structure is divided into two layers: an electrolysis layer at the bottom and a catalytic layer on top. Hydrogen generated through electrolysis in the lower layer acts as a reducing agent, and nitrates are reduced to nitrogen gas by the action of Pd or Pd—Cu catalyst in the upper layer. This technology has two main drawbacks: (1) the use of expensive precious metal palladium, and (2) the cases treated in this method have nitrate concentrations as low as 0.05-0.12 mg/L, resulting in relatively low overall cost-effectiveness.

Chinese patent document CN 202576056 U (2012) introduces a method for direct electrolysis of nitrate nitrogen, combined with a filtration tank containing activated carbon and zeolite to remove ammonia and nitrite as patented features. The main drawback of this device lies in its low efficiency. Despite using a current of 50 A and employing 0.3 g/L of sodium chloride as the electrolyte to generate hypochlorous acid, the reduction of 40.4 mg/L NO₃—N to 9.3 mg/L (a removal rate of 77.11%) takes a surprisingly long 180 minutes.

Deng et al. (2016) proposed a bio-electrolysis method, where the organisms use anaerobic ammonium oxidation (Anammox) bacteria. Electrolysis is used to reduce the existing nitrate nitrogen in water to ammonia nitrogen, and then the anaerobic ammonium oxidation (Anammox) transforms ammonia nitrogen to nitrogen gas. The key lies in the addition of iron scraps to the water body, which enables the oxidation of iron to produce hydrogen. This hydrogen is then utilized to further reduce nitrate to nitrogen gas. Simultaneously, the oxidation of iron helps reduce nitrate nitrogen to ammonia nitrogen for biological use. However, this technique has several drawbacks: (1) the utilization of Anammox bacteria, which are widely considered challenging to operate and control within the environmental engineering field; (2) the requirement for filling the packed tower reactor with substantial amounts of iron scraps and activated carbon, potentially leading to the need for disposal of activated carbon waste in the future; (3) concerns about elevated iron ion concentrations in water, which could lead to reddish water; (4) the demonstrated nitrate nitrogen concentrations are all below 30 mg/L, making the cost of this method prohibitively high given the aforementioned method.

### SUMMARY OF THE INVENTION

The water treatment method presented in this invention combines PVA gel beads with an electrolysis device, creating an innovative approach that integrates biological and electrolytic actions for water treatment. This method leverages the advantages of both actions, allowing them to function effectively. The microorganisms entrapped within the PVA gel beads are protected from being harmed by the presence of the chemical substances generated by the electrolytic action. Firstly, this invention addresses common drawbacks of traditional biological methods, such as: (1) Traditional biological nitrification/denitrification (AO) processes requiring the addition of carbon sources for denitrification; (2) Incomplete removal of certain pollutants, often leaving behind hard-to-degrade substances like COD from dye pigments or ammonia nitrogen from nitrogen-containing TMAc; (3) Limitations in the degradation of organic carbon and ammonia nitrogen in water bodies, such as pig farming wastewater, arisen due to imbalanced Carbon-to-Nitrogen (C/N) ratios; (4) Less stable biological action. Secondly, the water treatment method proposed by this invention can even enhance the microbial degradation capacity through the electrolytic action, enabling ordinary microorganisms to possess anaerobic ammonium oxidation capabilities. This enhances the superiority and feasibility of PVA gel beads in water treatment.

In Taiwan, the Environmental Protection Administration (EPA) has included the discharge of ammonia nitrogen (NH₃—N), nitrate nitrogen (NO₃—N), and total nitrogen (referred to as T-N) into the scope of effluent control in addition to the control of COD. These standards are progressively becoming stricter. By 2027, all industries, water resource centers, and public sewage systems are required to meet the most stringent standards: NH₃—N<10 mg/L, NO₃—N<50 mg/L, T-N<15 mg/L. Currently, for the low- and medium-concentrations of ammonia nitrogen, nitrate nitrogen, and total nitrogen in water bodies, biological treatments are employed. These include methods such as (1) the design of an AO reaction tank, involving denitrification followed by nitrification, or (2) the ammonia is directly converted into nitrogen gas by anaerobic ammonium oxidation bacteria (Anammox) into the atmosphere. However, denitrification necessitates the addition of extra carbon sources (such as ethanol, acetic acid, or glucose), which not only escalates operational costs but also augments sludge production and the risk of exceeding effluent COD standards. Furthermore, the use of Anammox bacteria in biological treatment systems, although not necessitating carbon sources, is highly unstable and challenging to manage. As such, the objective of this invention is to provide a novel water treatment method by combining PVA gel beads with an electrolysis device to perform both biological and electrolytic actions on water bodies. This invention leverages the natural propensity of biological action to degrade organic matters and hydrolyze organic nitrogen, along with the propensity of electrolytic action to prioritize the degradation of nitrate ions in freshwater environments (where water salinity <0.05%) without requiring additional carbon sources. In environments with halide-containing water bodies, the electrolytic action will prioritize the degradation of both nitrate ions and ammonia nitrogen. Concurrently, this invention has discovered that electrolytic action facilitates ordinary microorganisms entrapped within PVA gel beads to undergo anaerobic ammonium oxidation reactions without the generation of nitrate nitrogen. This process is termed the “Energized Anammox Reaction.” The mentioned ordinary microorganisms are non-Anammox bacteria. Consequently, the water treatment method of this invention can be categorized into the following six combination scenarios for adaptation to various contexts (as shown in FIG. 1).

(Scenario 1: Direct Electrolysis of Nitrate Ions) The PVA gel beads and the electrolysis device of this embodiment can be operated in various configurations, either in series or in combination. In this embodiment, the method involves the treatment of nitrogen-containing water bodies. First, the PVA gel beads are employed to facilitate the process of nitrification, leading to the formation of nitrate ions. These nitrate ions are subsequently subjected to an electrolytic action for denitrification. In cases where the nitrogen-containing substance in the water body is nitrate nitrogen, direct electrolysis is feasible without the necessity of adding any substances, including carbon sources. In instances where a dual-tank reaction system is employed, the biological action, such as biological nitrification, can be conducted in the first tank, followed by the electrolytic denitrification process in the second tank. This embodiment can utilize non-membrane with close spacing arrangement electrodes. Additionally, the embodiment allows for the option of employing recirculation or not.

(Scenario 2: Leveraging Microbial Degradation of Organic matters) The PVA gel beads and the electrolysis device of this embodiment can be operated in various configurations, either in series or in combination. In this embodiment, the method is directed towards nitrogen-containing water bodies with high Carbon-to-Nitrogen (C/N) ratios. Initially, the PVA gel beads are employed to facilitate the degradation of organic matters, potentially involving partial nitrification during the process. Ultimately, an electrolytic action is employed to remove residual pollutants (such as biologically recalcitrant organic compounds, ammonia nitrogen, and/or nitrate nitrogen). For this purpose, a small amount of sodium chloride (NaCl) must be introduced to stimulate the electrolytic reactions of the pollutants. In cases of insufficient salinity, a minor quantity of salts such as NaCl, KCl, CaCl₂, MgCl₂, etc., can be added.

(Scenario 3: Microbial hydrolysis of organic nitrogen is better than chemical oxidation.) The PVA gel beads and the electrolysis device of this embodiment can be operated in various configurations, either in series or in combination. The PVA gel beads are employed in this embodiment to facilitate the hydrolysis of organic nitrogen, followed by utilizing electrolytic action to remove ammonia nitrogen that is significantly generated due to biological action. The microorganisms entrapped within the aforementioned PVA gel beads, for instance, can be heterotrophic bacteria. In cases where there is an insufficient presence of chloride ions in the water body, a minor quantity of sodium chloride (NaCl) can be additionally added.

(Scenario 4: Utilizing electrolytic action for direct conversion of ammonia nitrogen and nitrate ions to nitrogen gas in high salinity water bodies) High salinity water bodies are commonly encountered in industrial wastewater, black pig farming wastewater, dialysis wastewater, and even in certain laundry industries where salt is used as a cleaning agent. Salt in kitchen waste comes from seasoning during cooking, while the source of salt in industrial wastewater includes coagulation and neutralization processes. Furthermore, the salt in TMAc wastewater originates from adding hydrochloric acid to TMAH wastewater, resulting in the formation of chlorides. Chloride ions and ammonia nitrogen released after hydrolysis are dissolved in water.

Taking wastewater from Taiwan's black pig farming as an example, black pigs are commonly fed with kitchen waste. The conventional three-stage treatment process (inclined screen, anaerobic, aerobic) does not effectively treat ammonia nitrogen. Eventually, the high ammonia nitrogen concentration in the wastewater leads to a reduced C/N ratio, instantaneously inhibiting the removal of organic matter. Regulations have been adjusted to address this situation by increasing the COD discharge standard for pig farming wastewater to 600 mg/L, which is the most lenient among all effluent standards. However, if a method could be employed to reduce the high concentration of ammonia nitrogen first, it would positively impact the overall purification of the water body.

Regarding halide-containing water bodies: The PVA gel beads and the electrolysis device of this embodiment can be operated in various configurations, either in series or in combination. In this embodiment, the method involves initially employing electrolytic action to remove high concentrations of ammonia nitrogen, nitrate nitrogen (which may contain some organic matters). Once the C/N ratio is elevated, the residual COD and nitrogen-containing substances are subjected to biological action using PVA gel beads. The pollutants removed (including organic matters and nitrogen-containing substances) could also potentially be completely decomposed through electrolytic action. However, biological action is the most economically effective. If the load on the biological action could be reduced, the extent of electrolysis action in the pre-treatment will depend on economic benefits. In this embodiment, if halide-containing water bodies are directly used as the electrolyte, the generated hypochlorous acid will not directly harm the microorganisms within the PVA gel beads. This is because the PVA gel beads provide a good shield for the microorganisms.

(Scenario 5: Electrolytic action in parallel with biological action) The PVA gel beads and the electrolysis device of this embodiment can be operated in various configurations, either in series or in combination. In this embodiment, biological action is parallelly coupled with electrolytic action. Although biological action is generally cost-effective, it can suffer from instability. When the efficiency of biological action declines, such as in the removal of nitrate nitrogen, ammonia nitrogen, or organic matter, the electrolytic system can be immediately activated to assist the biological action. This facilitates the decomposition of organic matter, ammonia nitrogen, and nitrate nitrogen.

(Scenario 6: Anaerobic ammonium oxidation by microorganisms within PVA gel beads) The PVA gel beads and the electrolysis device of this embodiment can be operated in various configurations, either in series or in combination. In this embodiment, for water bodies lacking inherent conductivity, ammonia nitrogen cannot undergo direct electrolysis. However, the addition of PVA gel beads to the reaction tank enables intermittent electrolytic action. During non-electric periods, biological action takes place, while complete electrolysis action accelerates the decomposition of ammonia nitrogen. In a single-tank reaction system, the oxygen generated at the anode of the electrolysis device can be supplied to the microorganisms within the PVA gel beads for nitrification, and the hydrogen generated at the cathode of the electrolysis device can be utilized to reduce nitrate ions. Due to the absence of chloride ions in the water body, the limited oxidation results in incomplete oxidation of ammonia nitrogen and suboptimal reduction. The biological nitrification and electrolytic denitrification reactions progress at the same time. Therefore, nitrite nitrogen accumulates within the reaction tank, facilitating its reaction with ammonia nitrogen to form nitrogen gas.

In order to make the above and other objectives, features, and advantages of the present invention more comprehensible, the following examples are provided in conjunction with the accompanying drawings for detailed explanation.

### BRIEF DESCRIPTION OF THE DRAWINGS

FIG. 1 is a schematic diagram of various scenarios covered by the present invention.

FIG. 2A is a schematic diagram of a reactor configuration used in an embodiment of the present invention.

FIG. 2B is a schematic diagram of a reactor configuration used in another embodiment of the present invention.

FIG. 2C is a schematic diagram of a reactor configuration used in another embodiment of the present invention.

FIG. 2D is a schematic diagram of a reactor configuration used in another embodiment of the present invention.

FIG. 2E is a schematic diagram of a reactor configuration used in another embodiment of the present invention.

FIG. 3 illustrates a flowchart of the steps of a water treatment method according to an embodiment of the present invention.

FIG. 4 depicts the trends of degradation of ammonia nitrogen and nitrate, as well as the change of chemical oxygen demand (COD), during electrolysis experiments conducted in low-salinity water bodies according to an embodiment of the present invention.

FIG. 5 illustrates the variation of ammonia nitrogen and nitrate nitrogen over time during direct electrolysis of a water body that has undergone biological treatment from a corrugated- and cardboard-packaging industry, according to an embodiment of the present invention, conducted in a laboratory setting.

FIG. 6 illustrates the variation of ammonia nitrogen and nitrate nitrogen over time during direct electrolysis of a water body that has undergone biological treatment from a corrugated- and cardboard-packaging industry, according to an embodiment of the present invention, conducted in a laboratory setting.

FIG. 7 illustrates the variation of ammonia nitrogen and nitrate nitrogen over time during direct electrolysis of a water body that has undergone biological treatment from a corrugated- and cardboard-packaging industry, according to an embodiment of the present invention, conducted in a laboratory setting.

FIG. 8 illustrates the variation of ammonia nitrogen and nitrate nitrogen over time during direct electrolysis of a water body that has undergone biological treatment from a corrugated- and cardboard-packaging industry, according to an embodiment of the present invention, conducted in a laboratory setting.

FIG. 9 depicts the changes in degradation of ammonia nitrogen and nitrate during electrolysis conducted in a high-salinity water body from the laundry industry, according to an embodiment of the present invention.

FIG. 10 illustrates the variation of influent ammonia nitrogen over time using PVA gel beads to degrade on-site wastewater from a corrugated- and cardboard-packaging industry, following electrolysis, according to an embodiment of the present invention.

FIG. 11 illustrates the variation of influent nitrate nitrogen over time using PVA gel beads to degrade on-site wastewater from a corrugated- and cardboard-packaging industry, following electrolysis, according to an embodiment of the present invention.

FIG. 12 illustrates the variation of influent COD over time using PVA gel beads to degrade on-site wastewater from a corrugated- and cardboard-packaging industry, following electrolysis, according to an embodiment of the present invention.

FIG. 13 illustrates the variations of influent COD, NH₃—N, and NO₃—N over time using PVA gel beads to degrade on-site wastewater from a corrugated- and cardboard-packaging industry, following electrolysis, according to an embodiment of the present invention.

FIG. 14 represents a scenario in which 1-L shaking flasks were employed to demonstrate the utilization of 10% PVA gel beads for the biological hydrolysis of a diluted 10% TMAc wastewater, according to an embodiment of the present invention.

FIG. 15 illustrates a scenario in which a 1-L shaking flasks were employed to demonstrate the changes in ammonia nitrogen and nitrate nitrogen during electrolysis of 10% TMAc wastewater that had undergone hydrolysis using PVA gel beads, according to an embodiment of the present invention.

FIGS. 16A to 16C depict a scenario in which 0.5-L shaking flasks were employed to demonstrate electrolysis on laundry wastewater. Among them, FIGS. 16A to 16C illustrate the variations in (A) ammonia nitrogen, (B) nitrate nitrogen, and (C) total nitrogen (using Device 1, 10 W, 5 V, 2 A) respectively, according to an embodiment of the present invention.

FIG. 17 illustrates the variation in ammonia nitrogen (5 V, 2 A, 10 W) when laundry wastewater was treated with the addition of bleach (900 mg/L) and subjected to electrolysis in a 0.5-L shaking flask using Device 1, according to an embodiment of the present invention.

FIG. 18 illustrates the degradation of ammonia nitrogen utilizing Device 2 to perform electrolysis (4 V, 4 A) on laundry wastewater without the addition of bleach, according to an embodiment of the present invention.

FIG. 19 illustrates the instability of COD and ammonia nitrogen degradation in a scenario where PVA gel beads without dual microbial sources are used, according to an embodiment of the present invention.

FIG. 20 illustrates a series of experiments for the development of energized PVA gel beads conducted in a low-salinity water body with only electrolysis being carried out in this experiment as a comparison, according to an embodiment of the present invention.

FIG. 21 illustrates an embodiment of the present invention in a series of experiments for the development of energized PVA gel beads, using PVA gel beads in a low-salinity water body with intermittent electrolysis (15-minute suspension every two hours).

FIG. 22 illustrates an embodiment of the present invention in a series of experiments for the development of energized PVA gel beads, using PVA gel beads in a low-salinity water body with continuous electrolysis throughout the duration.

FIG. 23 illustrates the changes in ammonia nitrogen and nitrate nitrogen during intermittent electrolysis experiments (15-minute suspension every two hours) using PVA gel beads with Device 1 in a high-salinity water body, according to an embodiment of the present invention.

FIG. 24 illustrates an embodiment of the present invention in a series of experiments for the development of energized PVA gel beads, using PVA gel beads in a high-salinity water body with continuous electrolysis throughout the duration.

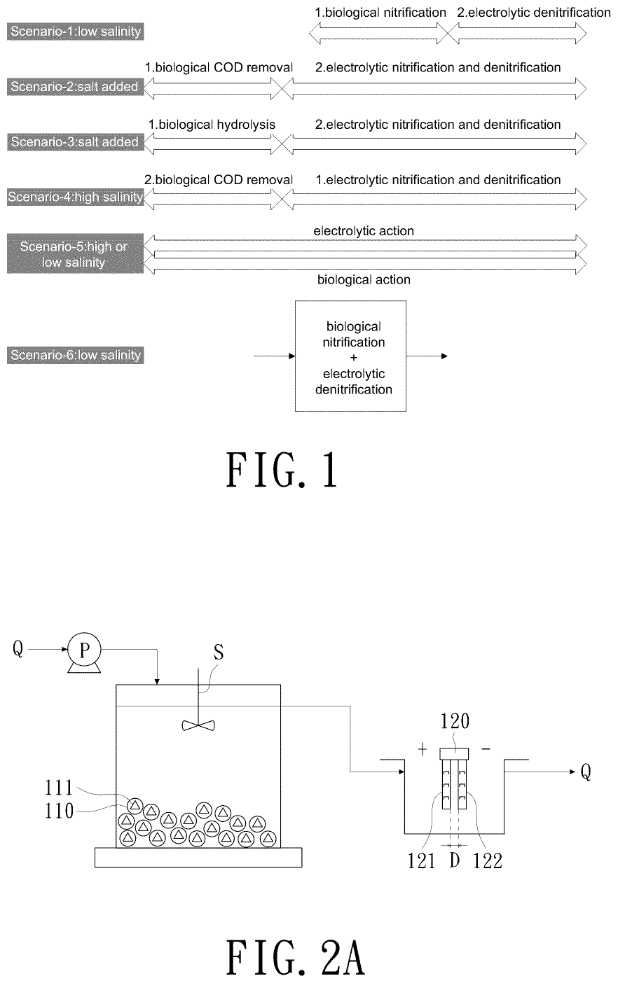

### DETAILED DESCRIPTION OF PREFERRED EMBODIMENTS

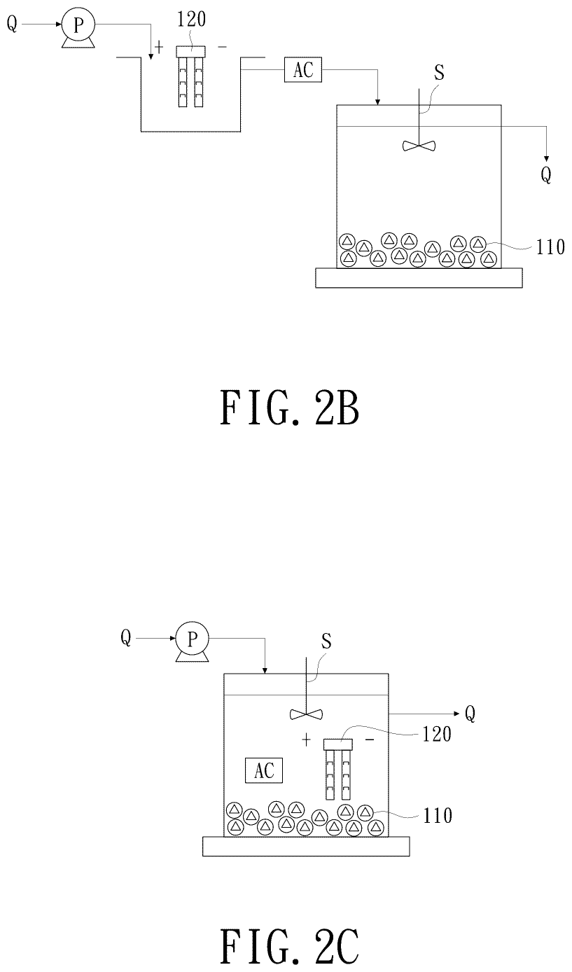

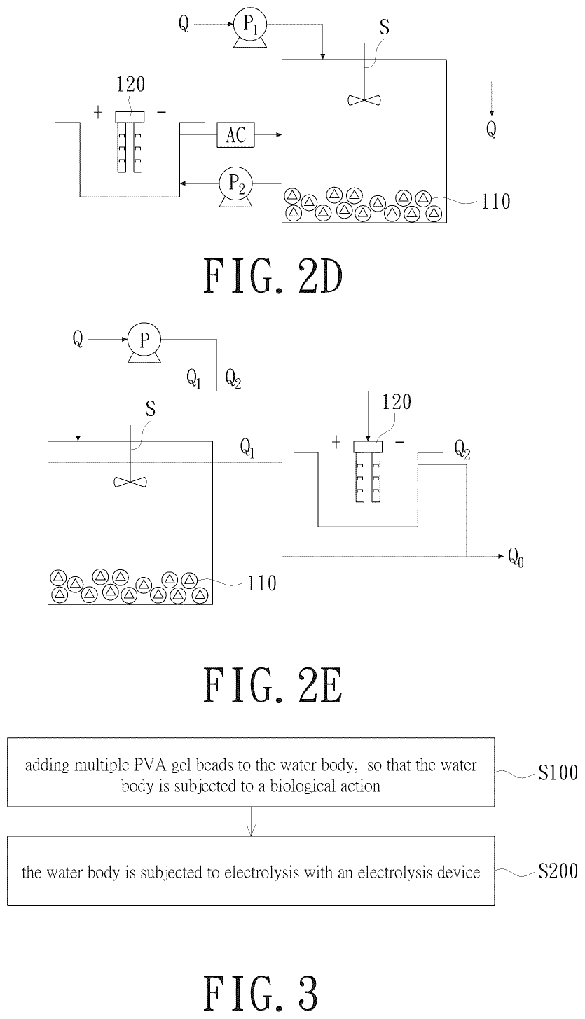

In the embodiments of the present invention, the types of reactors used for conducting biological action (hereinafter referred to as “bioreactors”) encompass all commonly known bioreactors, including batch stirred-tank reactors, continuous stirred-tank reactors (CSTR), plug-flow reactors, airlift reactors, fluidized bed reactors, and the like. These reactors can be used in conjunction with activated sludge or PVA gel beads. Similarly, reactors subjected to electrolytic actions through an electrolysis device are also included. Refer to FIG. 2A for reference. In this embodiment, the electrodes of the electrolysis device 120 are more important than the housing of the reactors in which the electrolysis is carried out. The electrolysis device 120 employed in the embodiment of the present invention, for instance, may include a first electrode 121 and a second electrode 122. The first electrode 121 and the second electrode 122 are, for example, connected or separated from each other by a distance D. In the embodiments described below, the first electrodes 121 may be anodes, and the second electrodes 122 may be cathodes. However, the present invention is not limited thereto. In other embodiments of the present invention, the first electrodes can be cathodes, and the second electrodes can be anodes. Furthermore, the distance D between the first electrode 121 and the second electrode 122 is, for example, between 2 mm and 50 mm, preferably between 2 mm and 20 mm, such as 4, 6, 8, 10, 12, 14, 16, or 18 mm, but the present invention is not limited thereto.

The materials used for the electrodes in this embodiment are, for instance, all dimensionally stable anodes (DSA) or titanium metal for the second electrode. In other words, both the first electrode 121 and the second electrode 122 in this embodiment may be DSA electrodes, or the first electrode 121 may be a DSA electrode while the second electrode 122 is a titanium metal electrode. However, the present invention is not limited thereto. The aforementioned DSA electrodes may include a base layer, an intermediate layer and a surface layer. The material of the base layer may be titanium metal, the material of the intermediate layer may be iridium, tin, or a combination thereof, and the material of the surface layer may be ruthenium.

The combination types of the reactors in the embodiments of the present invention include four variations, as shown in FIGS. 2A to 2E. It should be noted that in the embodiments depicted in FIGS. 2A to 2E, the water bodies Q and Qₒ are, for example, pumped and introduced into or flow between the reactors using pumps P, P₁, and P₂. The reactor incorporating the PVA gel beads 110 of the embodiments of the present invention includes, for example, an agitator S, which facilitates the thorough mixing of the PVA gel beads 110 with the water body Q to promote biological action. The agitator S may include mixing blades, but the present invention is not limited thereto. Furthermore, activated carbon (AC) may be introduced into the reactor in the embodiments of the present invention. The activated carbon (AC) can adsorb hypochlorous acid in the water body Q. However, the present invention is not limited thereto.

FIG. 3 illustrates a flowchart of the steps of a water treatment method according to an embodiment of the present invention. Please refer to FIGS. 2A and 3. The water treatment method of the embodiment of the present invention is suitable for water treatment of a water body Q containing nitrogen-containing substances. The water treatment method includes the following steps: adding multiple PVA gel beads 110 to the water body Q, so that the water body Q is subjected to a biological action. This step is designated as S100. Additionally, the water body Q is subjected to electrolysis with an electrolysis device 120, as indicated by step S200. The aforementioned PVA gel beads 110 entrap at least one type of microorganism 111, enabling the PVA gel beads 110 to facilitate biological action in water body Q. At least one type of microorganism 111 may include autotrophic nitrifying bacteria, heterotrophic nitrifying bacteria, yeast, microorganisms suitable for degrading organic matter, algae, or a combination thereof. However, the present invention is not limited thereto. Furthermore, in this embodiment, the quantity of PVA gel beads 110 is, for example, more than one; the numbers of the type of microorganism 111 entrapped in each PVA gel bead 110 is, for example, one; and the microorganism 111 entrapped in each PVA gel bead 110 is, for example, the same. However, the present invention does not impose specific limitations in this regard. In another embodiment of the present invention, PVA gel beads may entrap multiple types of microorganisms, and PVA gel beads entrapped with different types of microorganisms may be used. Additionally, the quantity of PVA gel beads in the embodiment of the present invention is typically calculated as a proportion of the reactor volume. It may be adjusted according to usage requirements. For example, in aerobic treatment of industrial wastewater, PVA gel beads may constitute 5-15% (w/v) of the reactor volume, while in anoxic or anaerobic treatment of industrial wastewater, PVA gel beads may constitute 5-30% (w/v) of the reactor volume. However, the present invention does not impose specific limitations in this regard.

It is worth mentioning that the PVA gel beads 110 used in the water treatment method of the embodiments of the present invention entrap at least one type of microorganism 111. In one embodiment of the present invention, the PVA gel beads 110 include at least one type of microorganism 111, and may further include crosslinked PVA units, polyurethane (PU), and PVA units. Other substances may also be entrapped within the PVA gel beads, such as cells or enzymes. The size of the PVA gel beads is, for instance, between 2 mm and 6 mm, preferably between 3 mm and 5 mm, and even more preferably around 4 mm. The hardness of the PVA gel beads is, for example, greater than or equal to approximately 0.03 kg/cm², preferably greater than or equal to approximately 0.1 kg/cm², and even more preferably greater than or equal to approximately 0.5 kg/cm². Moreover, after one week of using the PVA gel beads in the water treatment method, less than approximately 10% of PVA, microorganisms, or other substances may leak from the PVA gel beads. Preferably, after one week of using the PVA gel beads in the water treatment method, less than approximately 1% of PVA, microorganisms, or other substances may leak from the PVA gel beads. In the most preferred scenario, after one week of using the PVA gel beads in the water treatment method, less than approximately 0.1% of PVA, microorganisms, or other substances may leak from the PVA gel beads. The superior physical structure of the PVA gel beads contributes to their reduced susceptibility to disintegration and provides the advantage of minimal leakage. However, the present invention is not limited by this specific aspect.

The water bodies Q treated by the water treatment method in the embodiments of the present invention include, for example, pre-treated water in water supply, domestic sewage, wastewater, aquaponics water, and aquaculture water. The pre-treated water is, for example, water collected from intake points, conduits, reservoirs, and equalization tanks of water treatment plants. The wastewater refers to water containing pollutants generated by business entity during manufacturing, operation, or natural resource extraction processes, or within working environments. The above-mentioned wastewater includes wastewater from scrubbers used for air pollution control. The aforementioned business entity includes industry, agriculture, fisheries and animal husbandry. Sewage (also known as domestic sewage) refers to water containing pollutants generated by sources other than businesses.

Please continue to refer to FIG. 2A and FIG. 3. In this embodiment, the water treatment method involves performing step S100 followed by step S200, i.e., initiating biological action in the water body Q before subjecting the water body Q to electrolysis. However, the invention is not specifically limited thereto. In another embodiment of the present invention, the water treatment method may involve performing step S200 followed by step S100, i.e., conducting electrolysis on the water body Q prior to adding PVA gel beads 110 to engage in biological action, as shown in FIG. 2B. In yet another embodiment of the present invention, the water treatment method may simultaneously perform step S100 and step S200, i.e., conducting electrolysis and biological action concurrently, as shown in FIG. 2C and FIG. 2D, wherein FIG. 2C represents internal circulation and FIG. 2D represents external circulation. The specific details of internal and external circulation will be described in subsequent paragraphs. Additionally, in another embodiment of the present invention, the water body Q₀ can be divided into two parts, allowing one part, water body Q1, to undergo biological action (i.e., step S100), and the other part, water body Q2, to undergo electrolysis (i.e., step S200). However, the present invention is not limited thereto.

### Example 1: Direct Electrolysis of Nitrate Ions

The water source for this embodiment is the cleaning wastewater from a corrugated- and cardboard-packaging factory's printing equipment in Taiwan. The wastewater has a COD of approximately 2000 mg/L and an ammonia nitrogen concentration of 200-300 mg/L, with a conductivity of about 5 mS. The original wastewater does not contain nitrate nitrogen. The wastewater subjected to the electrolysis in this embodiment is the wastewater that has undergone treatment with PVA gel beads. These PVA gel beads entrap microorganisms, such as heterotrophic bacteria and nitrifying bacteria. In other words, in this embodiment, the water is, for example, subjected to a biological action before undergoing electrolysis. After the treatment of biological action, the COD of the wastewater is approximately 300-350 mg/L, ammonia nitrogen is around 200 mg/L, and nitrate nitrogen is approximately 160 mg/L, resulting in a C/N ratio of only 1.5. The electrolysis device used in this embodiment is a commercially available small-scale electrolysis cell (volume of 350 mL, with the first and second electrodes complementarily combined to form a circular shape with a diameter of 4 cm. The electrolysis is conducted at 5 V and 2 A, delivering 10 W of power).

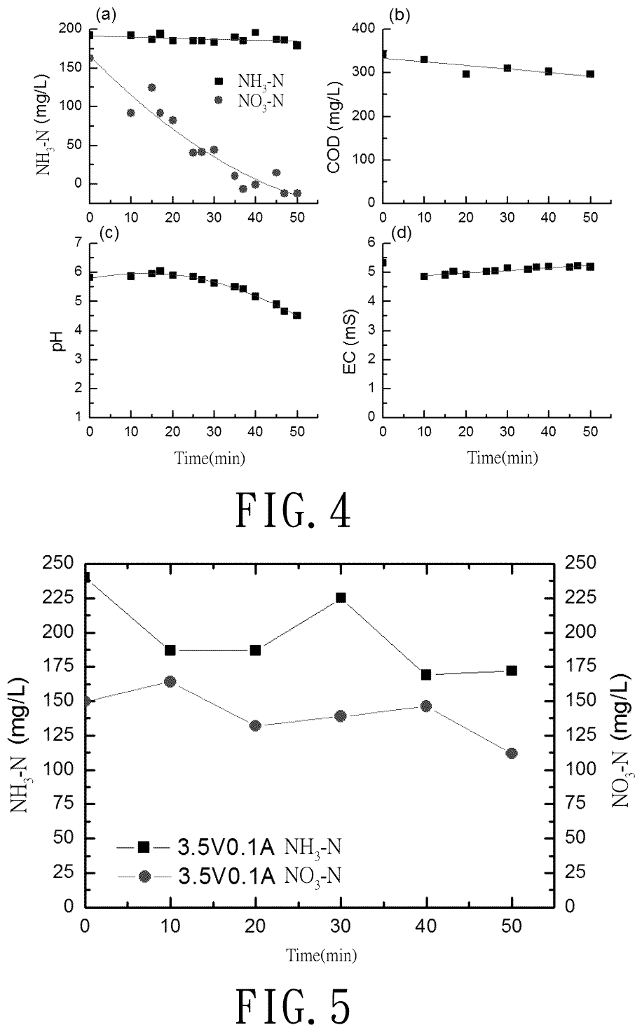

The present invention provides an embodiment wherein the degradation of ammonia nitrogen and nitrate nitrogen following a biological action is conducted in a low-salinity aquatic environment through electrolysis, as illustrated in FIG. 4. In the electrolysis process of this embodiment, ammonia nitrogen and nitrate nitrogen exhibit distinct degradation trends along the time axis. Nitrate nitrogen is rapidly reduced without the addition of any carbon source (such as ethanol, acetic acid, or glucose), reaching zero at 35 minutes. On the other hand, the concentration of ammonia nitrogen remains constant until the end of the reaction. This indicates that an alternative method for oxidizing ammonia nitrogen is needed, and the most cost-effective method lies in the biological nitrification. Consequently, the water treatment method provided by this invention combines “biological action (specifically, biological nitrification)” and “electrolytic action (specifically, electrolytic reduction of nitrate)” for the removal of nitrogen-containing substances from water, yielding superior results compared to the use of unstable anaerobic ammonia-oxidizing bacteria alone.

Continuing with reference to FIG. 4. The degradation of nitrate in this embodiment is notably significant in comparison to other parameters such as COD, pH value, and electrical conductivity (EC). As indicated by FIG. 4, electrical conductivity exhibits a pronounced increase. The pH value remains stable for a period of time at the beginning of the experiment. After the 18th minute, the pH value began to drop rapidly. By the 50th minute, the pH value reaches 4.3, and measurement of hypochlorous acid concentration in the water is zero. As for COD, there is a slight decomposition, which is statistically significant due to the t-value of the slope being 0.03872, less than 0.05 in the t-test.

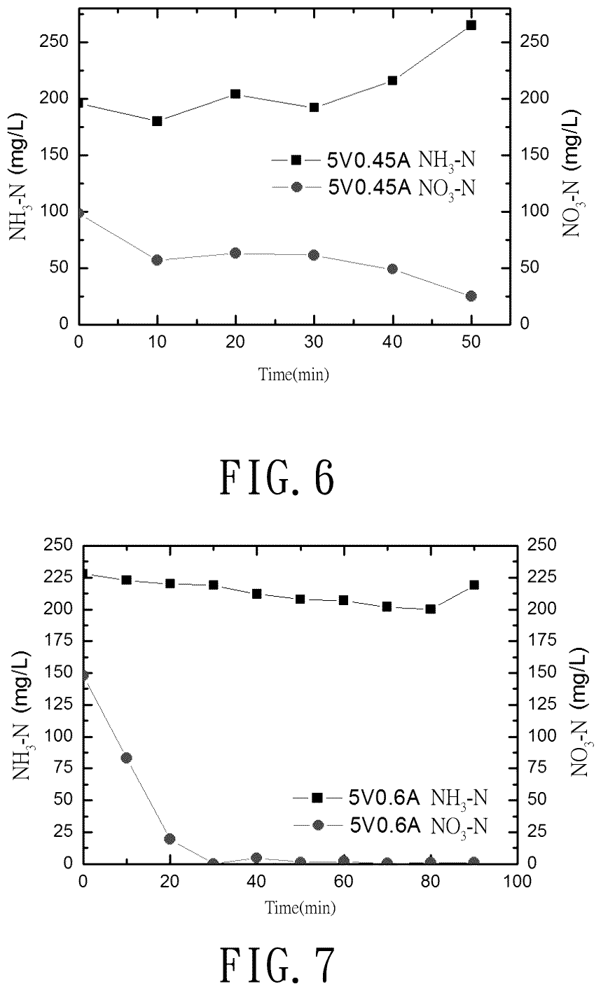

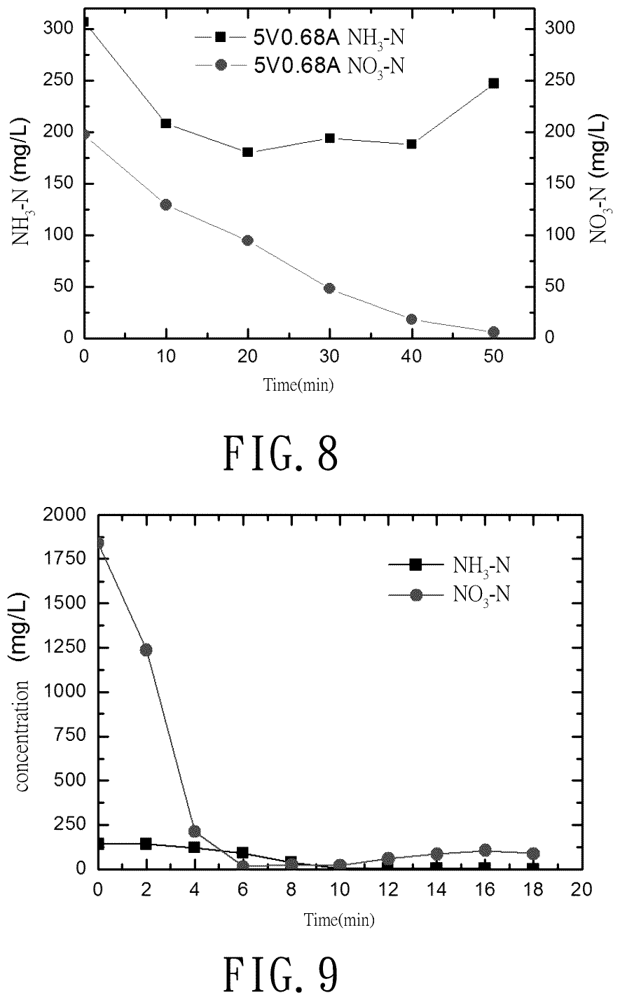

FIG. 5 illustrates the change of ammonia nitrogen and nitrate nitrogen over time in a water body subjected to electrolysis after biological action in an embodiment of the present invention. In this embodiment, the second electrode is, for instance, made of titanium, and the first electrode is, for instance, made of titanium. The dimensions of a single electrode are, for example, 3 cm*8 cm*0.2 cm. The volume of the water body is, for example, 0.5 L. The setting of the electrolysis device is, for example, 3.5 V and 1 A. FIG. 6 illustrates an embodiment of the present invention where a water body treated by a biological action in the corrugated- and cardboard-packaging industry is subjected to direct electrolysis in a laboratory setting, illustrating the changes over time in ammonia nitrogen and nitrate nitrogen concentrations. In this embodiment, the second electrode is, for example, made of Dimensionally Stable Anodes (DSA), while the first electrode is, for example, made of titanium. The dimensions of a single electrode are, for example, 3 cm*8 cm*0.2 cm. The volume of the water body is, for example, 0.5 L, and the setting of the electrolysis device is, for example, 5 V and 1 A. FIG. 7 illustrates the changes over time in ammonia nitrogen and nitrate nitrogen in an embodiment of the invention in the corrugated- and cardboard-packaging industry where the biologically treated water body underwent direct electrolysis in a laboratory. In this embodiment, the second electrode is, for example, made of titanium, while the first electrode is, for example, made of DSA. The dimensions of a single electrode are, for example, 3 cm*8 cm*0.2 cm. The volume of the water body is, for example, 0.5 L, and the setting of the electrolysis device is, for example, 5 V and 1 A. FIG. 8 illustrates the changes over time in ammonia nitrogen and nitrate nitrogen in an embodiment of the invention in the corrugated- and cardboard-packaging industry where the biologically treated water body underwent direct electrolysis in a laboratory. In this embodiment, the second electrode is, for example, made of DSA, and the first electrode is, for example, made of DSA. The dimensions of a single electrode are, for example, 3 cm*8 cm*0.2 cm. The volume of the water body is, for example, 0.5 L, and the setting of the electrolysis device is, for example, 5 V and 1 A. In the selection of electrolysis devices for this embodiment, a self-assembled electrolysis device is, for example, employed without the addition of sodium chloride. FIGS. 6 to 8 illustrate the current of this embodiment of the present invention ranging from a minimum of 0.45 A to a maximum of 0.68 A at a voltage of 5 volts. The operating voltages of the electrolysis device in this embodiment of the present invention, for example, range from 5 V to 100 V, with a preference for 5 V to 60 V, such as 10 V, 20 V, 30 V, 40 V, or 50 V, though the invention is not limited thereto. The operating currents of the electrolysis device in this embodiment of the present invention, for example, range from 1 A to 1000 A, with a preference for 10 A to 300 A, such as 50 A, 100 A, 150 A, 200 A, or 250 A, though the invention is not limited thereto.

The electrolysis device of this embodiment of the present invention operates with a current density of, for instance, from 5 to 100 mA/cm², preferably 20 to 30 mA/cm², such as 22, 24, 26, or 28 mA/cm², but the present invention is not limited thereto. Additionally, the operating temperatures of the electrolysis device in this embodiment of the present invention range, for example, from room temperature to 50° C., with a preference for room temperature. The mentioned room temperature, for example, falls within the range of 20 to 25° C.; however, the present invention does not impose specific constraints on this aspect. The operating temperature of the electrolysis device in this embodiment of the present invention can be maintained at room temperature, presenting the advantage of lower carbon emissions compared to the prior art (mainland China patent document CN 101693577 A) which has an operating temperature as high as 61° C. Furthermore, the electrolysis device in this embodiment of the present invention, for instance, performs electrolysis on the water body using either constant voltage or constant current, but the present invention is not limited thereto.

Please refer to FIGS. 5 to 8. The arrangement methods of the second electrode and the first electrode in embodiments of the present invention are as follows: (1) titanium, titanium, (2) DSA, titanium, (3) titanium, DSA, (4) DSA, DSA. The combination (1) demonstrates that titanium has poor conductivity and low current, resulting in no decomposition of ammonia nitrogen and nitrate nitrogen. In the comparison between combination (2) and combination (3), the use of titanium as the first electrode in combination (2) leads to significantly lower current, resulting in poorer degradation of nitrate nitrogen and a notable transfer to ammonia nitrogen, causing an increase in ammonia nitrogen. Although the difference in current levels of combinations (3) and (4) is small, there is a substantial difference in the degradation of ammonia nitrogen and nitrate nitrogen: when the second electrode of combination (3) is titanium, and the second electrode of combination (4) is DSA, the degradation efficiency of nitrate nitrogen is three times better in combination (3) compared to combination (4). Conclusion: Using titanium as the second electrode in combination (3) yields superior nitrate nitrogen removal, whereas selecting DSA as both the first and second electrodes in combination (4) results in better ammonia nitrogen removal. Therefore, in embodiments of the present invention, it is possible to choose appropriate combinations of the first electrode and the second electrode based on specific requirements, which will contribute to enhancing the removal efficiency of ammonia nitrogen and nitrate nitrogen.

FIG. 9 illustrates the changes of ammonia nitrogen and nitrate in a high-salinity water body (EC=30 mS) from the laundry industry through electrolysis in an embodiment of the present invention. In this embodiment, the electrolysis device is, for example, set at 10 V and 10 A. The size of the single electrode is, for example, 3 cm*8 cm*2 mm thickness. The first electrode is, for example, made of DSA. The second electrode is, for example, made of DSA. An initial nitrate nitrogen concentration of 1,750 mg/L can be completely degraded within 6 minutes. In comparison to the method for removing nitrate from water proposed in the prior art (mainland China patent document CN 101704595 A), where the concentration of nitrate treated was only 0.05-0.12 mg/L, the nitrate removal effect of this embodiment of the present invention is significantly better. On the other hand, compared to this embodiment, prior art (CN 202576056 U) using a platinum first electrode and a zinc second electrode required 180 minutes to reduce NO₃—N from 40.4 mg/L to 9.3 mg/L (removal rate of 77.11%), which is hypothesized to be due to the poor selection of the first electrode and the second electrode in the prior art, leading to lower removal efficiency. From the chemical reaction equations, it can be deduced that the primary denitrification reaction takes place at the cathode, where hydrogen gas generated at the cathode reduces nitrate ions to nitrogen gas, with a small amount forming ammonia nitrogen. For the electrolytic action, two scenarios are described in this embodiment as follows: (1) If chloride ions are absent in the water, hypochlorous acid will not be produced. In this situation, only nitrate ions will be reduced. Subsequently, existing ammonia nitrogen in the water or small amounts generated through electrolytic reduction can undergo nitrification by nitrosomonas bacteria and nitrifying bacteria. (2) If some chloride ions are present in the water, hypochlorous acid water will be generated. In this case, ammonia nitrogen will be removed as quickly as nitrate ions.

### Example 2: High C/N Ratio First Degradation of Organic Matter by PVA Gel Beads

The water source for this embodiment is the same as that in Example 1, originating from the cleaning wastewater of a printing machine in a corrugated- and cardboard-packaging factory in Taiwan. The wastewater has a COD of approximately 2000 mg/L, ammonia nitrogen concentration ranging from 200 mg/L to 300 mg/L, conductivity around 5 mS, and no initial presence of nitrate nitrogen. The C/N ratio is as high as 10-fold. In this embodiment, the water body was not previously specifically subjected to any biological action using PVA gel beads (e.g., digestion bacteria action). The electrolytic device employed in this embodiment involves a water volume of, for example, 3 liters, a current of 3.869 A at 5 V, and the dimensions of each electrode plate are, for example, 59 cm*17 cm*2 mm thickness. The electrodes are, for example, one first electrode and two second electrodes. The submerged area in the water is approximately 50 cm², doubled for both sides, totaling 100 cm². The current density is, for example, set at 20 mA/cm². In this embodiment, at least one type of salt is added to the water body after biological action and before electrolytic action. The mentioned at least one salt is halogen-containing compounds, wherein the at least one salt includes sodium chloride, potassium chloride, calcium chloride, magnesium chloride or a combination thereof, although the present invention is not limited thereto. In this embodiment, the salt added is such as sodium chloride, with an injection rate of, for example, 20 mL per hour, and the concentration of sodium chloride is, for example, 1 kg/20 L. This results in an injection of 480 mL or 24 g per day. However, the present invention does not impose specific constraints on this aspect. Considering the wastewater flow rate of approximately 80 L per 6.2 days, which equates to 12.9 L per day, the concentration becomes 24 g/12.9 L=1.86 g/L. In comparison, the concentration of seawater is typically 35 g/L, making it approximately 41 times higher than the added salt concentration.

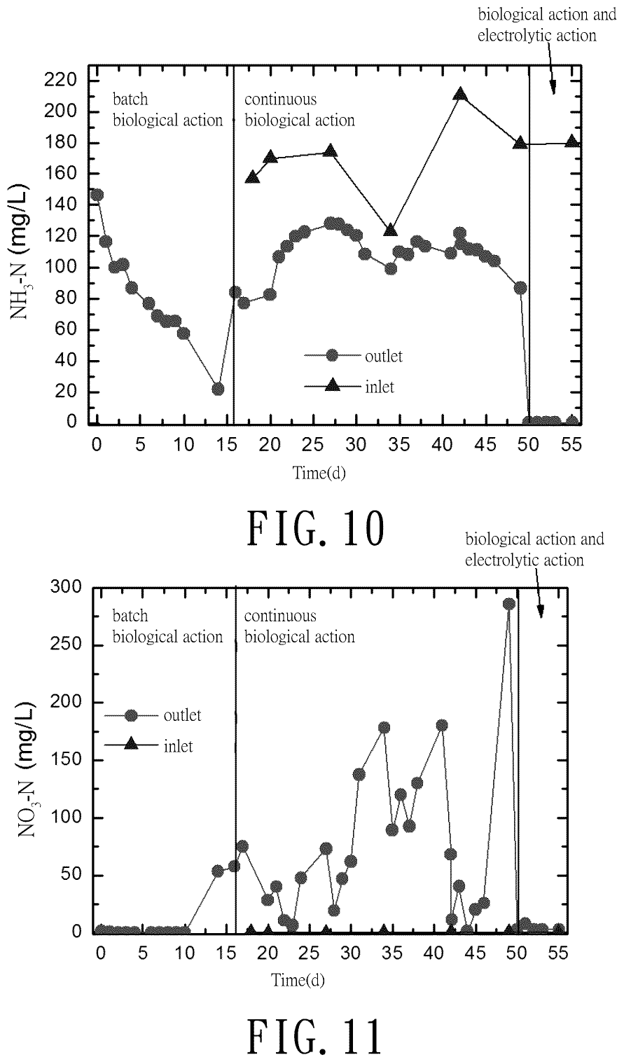

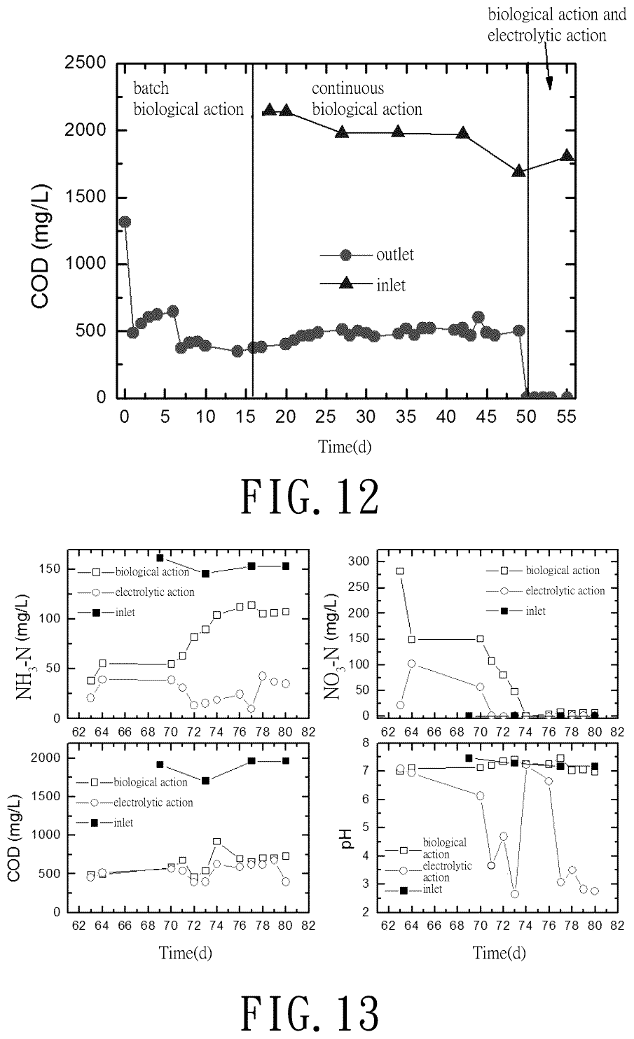

FIG. 10 illustrates the variation of influent ammonia nitrogen over time using PVA gel beads to degrade on-site wastewater from a corrugated- and cardboard-packaging industry, following electrolysis, according to an embodiment of the present invention. In this embodiment, retention time in the biological reactor is, for example, 6.2 days, while the retention time in the electrolytic reactor is, for example, 5.4 hours. The sodium chloride concentration is, for example, 1.8 g/L, and the electrolysis device is, for example, set at 5 V and 5 A, with a measured current value of, for example, 3.8 A. FIG. 11 illustrates the variation of influent nitrate nitrogen over time using PVA gel beads to degrade on-site wastewater from a corrugated- and cardboard-packaging industry, following electrolysis, according to an embodiment of the present invention. In this embodiment, retention time in the biological reactor is, for example, 6.2 days, while the retention time in the electrolytic reactor is, for example, 5.4 hours. The sodium chloride concentration is, for example, 1.8 g/L, and the electrolysis device is, for example, set at 5 V and 5 A, with a measured current value of, for example, 3.8 A. FIG. 12 illustrates the variation of influent COD over time using PVA gel beads to degrade on-site wastewater from a corrugated- and cardboard-packaging industry, following electrolysis, according to an embodiment of the present invention. In this embodiment, retention time in the biological reactor is, for example, 6.2 days, while the retention time in the electrolytic reactor is, for example, 5.4 hours. The sodium chloride concentration is, for example, 1.8 g/L, and the electrolysis device is, for example, set at 5 V and 5 A, with a measured current value of, for example, 3.8 A. This embodiment of the present invention uses PVA gel beads for biological action and electrolytic action in a high C/N ratio water body. For example, in this embodiment, the water body is batch biologically treated, followed by continuous biological action with influent, and subsequently, simultaneous biological action and electrolytic action. However, the present invention is not limited to these specifics. During the electrolysis experiment in this embodiment, the pH value dropped to 4.5, indicating the conversion of sodium chloride to a high concentration of hypochlorous acid, attributed to insufficient alkalinity buffering. In fact, electrolysis requires the addition of an appropriate amount of sodium chloride to ensure complete removal of organic compounds and ammonia nitrogen that are typically challenging for biological decomposition. In a subsequent experiment, the retention time in a biological reactor for biological action was reduced to 2 days, while 24 g of sodium chloride was still supplied daily. The results are illustrated in FIG. 13. FIG. 13 illustrates the variations of influent COD, NH₃—N, and NO₃—N over time using PVA gel beads to degrade on-site wastewater from a corrugated- and cardboard-packaging industry, following electrolysis, according to an embodiment of the present invention. In this embodiment, retention time in the biological reactor is, for example, 2 days, while the retention time in the electrolytic reactor is, for example, 1.8 hours. The sodium chloride concentration is, for example, 0.6 g/L, and the electrolysis device is, for example, set at 5 V and 5 A, with a measured current value of, for example, 1.2 A. Despite reducing the sodium chloride concentration to, for example, 0.6 g/L and shortening the retention time to one-third, COD exhibits no significant change. The ammonia nitrogen removal rate remains at 80%, and nitrate nitrogen gradually diminishes. The post-experiment sample was tested for total nitrogen, showing an approximate balance and the absence of residual nitrate nitrogen, indicating the absence of other significant nitrogen-containing substances in the water.

### Example 3: Utilization of Microbial Hydrolysis for Organic Nitrogen Degradation with Superior Attributes Compared to Chemical Oxidation Methods

In this scenario, the water source originates from a petrochemical plant specializing in the recovery and purification of tetramethylammonium hydroxide (TMAH) in a scientific park in Taiwan. The wastewater generated from TMAH purification is initially treated with hydrochloric acid to transform it into TMAc wastewater, reducing its toxicity. The COD of this wastewater is not measurable, the total nitrogen concentration is within the range of 1800-2100 mg/L (TMAc ranging from 14091-16440 mg/L), and the conductivity is 11.78 mS. The original wastewater does not contain nitrate nitrogen. Due to the toxic effects of TMAc on microorganisms, the TMAc in the wastewater needs to be diluted to around 10-20% concentration before conducting biological experiments. In this diluted form, the total nitrogen concentration is approximately 180-360 mg/L. The volume of the electrode plate used for electrolysis experiment is, for example, 3 cm*8 cm*2 mm thickness. The first electrode and the second electrode, for example, both use DSA electrodes. In the electrolysis experiment, the wastewater, which has undergone microbial hydrolysis using PVA gel beads containing heterotrophic bacteria, is subjected to electrolysis. The ammonia nitrogen concentration of this wastewater is approximately 180-360 mg/L (corresponding to 10-20% TMAc).

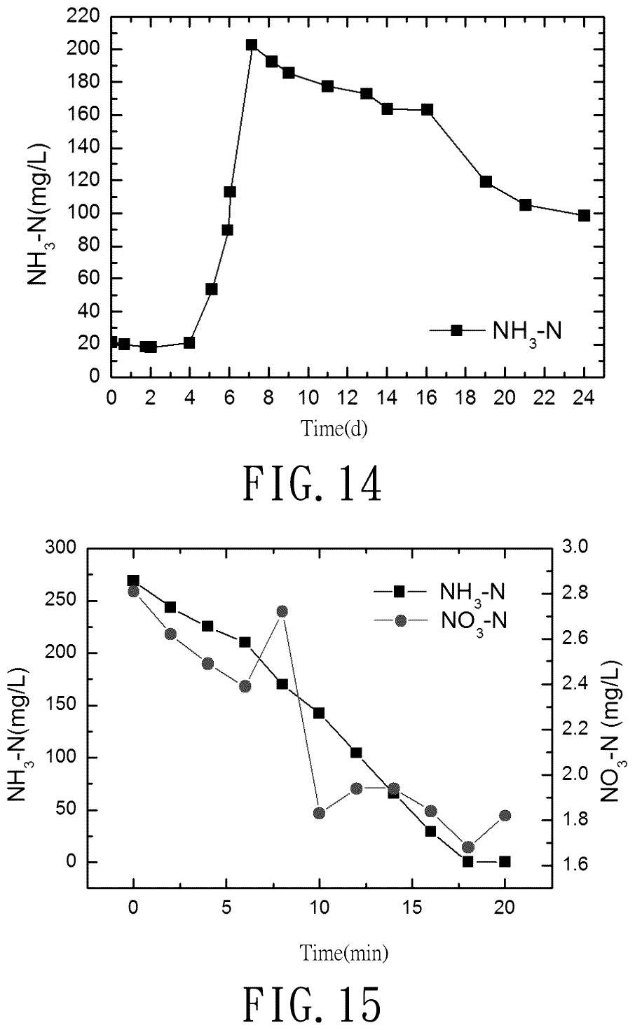

FIG. 14 depicts a pre-treatment embodiment of the present invention, illustrating the scenario in which TMAc wastewater is hydrolyzed to ammonia nitrogen by biological action. FIG. 15 represents a post-treatment embodiment of the present invention. As shown in FIG. 15, in this embodiment, under high-intensity electrolysis at 10 A and 10 V (NaCl 3 g/L), the concentration changes of ammonia nitrogen and nitrate nitrogen are shown. By the 18th minute, the ammonia nitrogen concentration has already been reduced to zero. Although nitrate levels are generally low and have been overlooked in the past, amplifying their trend also reveals a consistent reduction similar to ammonia nitrogen. From FIG. 14, it can be observed that subsequent ammonia nitrogen degradation is slow. According to the results of another embodiment of the present invention, using PVA gel beads entrapped with different bacterial sources, even after more than a month of biological hydrolysis, the ammonia nitrogen concentration still fluctuates between 200 mg/L and 300 mg/L. It is inferred that the PVA gel beads entrapped with heterotrophic bacteria may uptake ammonia nitrogen as a nitrogen source and then release the ammonia nitrogen after their death. Meanwhile, the autotrophic nitrifying bacteria entrapped in the PVA gel beads are likely suppressed under these conditions. Consequently, the optimal treatment strategy for TMAc wastewater involves initially subjecting it to biological hydrolysis using PVA gel beads entrapped with heterotrophic bacteria, resulting in the conversion of TMAc to ammonia nitrogen. Subsequently, the electrolysis method is employed to remove ammonia nitrogen from the treated wastewater.

### Example 4: Electrolyzing Ammonia Nitrogen and Nitrate Ions Under High Salinity Conditions

In this scenario, the water source originates from the wastewater generated by the washing process of the laundry industry, after undergoing a two-stage salt addition treatment. The COD of the wastewater is approximately 500-1000 mg/L, and the concentration of either ammonia nitrogen or total nitrogen is around 500 mg/L. The conductivity of the wastewater ranges from 15 mS to 30 mS. The power supply used in this embodiment may provide a direct current of 0-30 V and 0-10 A (Model: KPS3010DF, Wanptek). The electrolysis device used in this embodiment, for example, includes three variations: (1) A commercially available hypochlorous acid generator, no external power supply required, with a volume of 350 mL, operating at 5 V and 2 A, producing 10 W of power. The first and second electrodes are arranged in an alternating pattern to form a circular plate with a diameter of 4 centimeters. The gap between the two electrodes is approximately 2 mm. (2) A laboratory-made electrode configuration where the first electrode is centrally positioned and surrounded by two second electrodes. The gap between the first and second electrodes is 8 mm. Each electrode measures 55 mm in width, 100 mm in length, and 2 mm in thickness. The second electrode is, for example, made of titanium, while the first electrode is, for example, a DSA electrode.

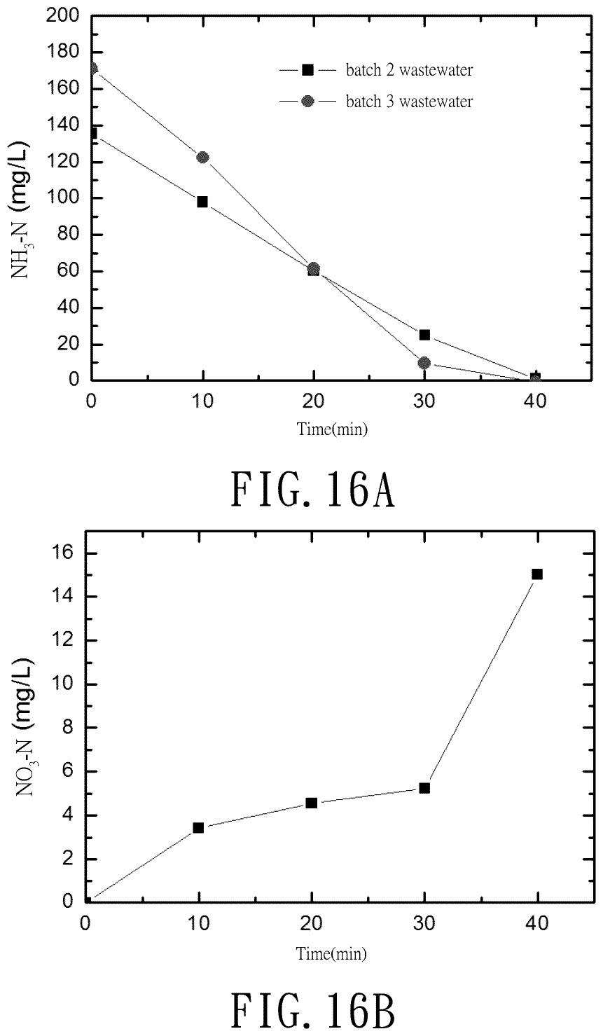

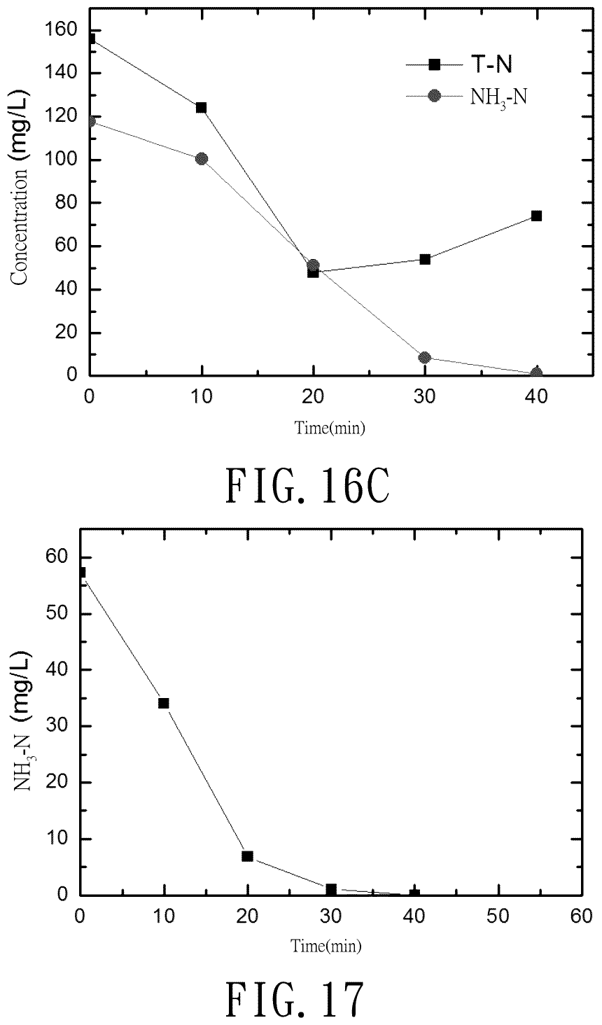

FIGS. 16A to 16C depict a scenario in which 0.5-L shaking flasks were employed to demonstrate electrolysis on laundry wastewater. Among them, FIGS. 16A to 16C illustrate the variations in (A) ammonia nitrogen, (B) nitrate nitrogen, and (C) total nitrogen (using Device 1, 10 W, 5 V, 2 A) respectively, according to an embodiment of the present invention. If the laundry wastewater is subjected to electrolysis, the conductivity ranges from 21.8 mS to 24.8 mS, such as 22, 23, and 24 mS. Complete degradation of ammonia nitrogen using Device 1 requires 30 to 40 minutes, as shown in FIG. 16A. No bleach was added in this embodiment, resulting in ammonia nitrogen concentrations ranging from 150 mg/L to 180 mg/L. The degradation efficiency of ammonia nitrogen was reported to be between 3.6 mg/L-min and 5.3 mg/L-min. Additionally, as ammonia nitrogen oxidizes, there is a slight increase in nitrate nitrogen levels. Total nitrogen initially decreased with the reduction in ammonia nitrogen but stabilized around 50 mg/L. This might be attributed to bacterial proliferation. Notably, the analysis conducted in this embodiment did not, for example, involve a filtration device.

In this embodiment, when the electrolytic action is conducted in conjunction with bleach (900 mg/L), the results are shown in FIG. 17. FIG. 17 illustrates the variation in ammonia nitrogen (5 V, 2 A, 10 W) when laundry wastewater was treated with the addition of bleach (900 mg/L) and subjected to electrolysis in a 0.5-L shaking flask using Device 1, according to an embodiment of the present invention. In this embodiment, the conductivity of the laundry wastewater ranges from 14.9 mS to 15.5 mS. The salinity is approximately 1.5%, which closely resembles the 3.5% salinity of seawater, rendering the addition of any further salt unnecessary. From FIG. 17, it is observed that the degradation of ammonia nitrogen using Device 1 only requires 20 minutes. The initial concentration of ammonia nitrogen is 58 mg/L. Comparing it with the ammonia nitrogen concentration in the laundry wastewater without added bleach, the same water body exhibits a lower concentration of ammonia nitrogen. It is believed that this decrease in ammonia nitrogen can be attributed to the degradation caused by the bleach. If the efficiency of both the bleach and electrolysis is combined, it could be around 8 mg/L-min, indicating a synergistic effect. If the disappearing ammonia nitrogen is not taken into account, the efficiency is only 2.5 mg/L-min, which is lower than the data without added bleach. The probable reason for this might be due to the higher conductivity in the group without added bleach, possibly indicating a higher salt content, hence the higher removal efficiency.

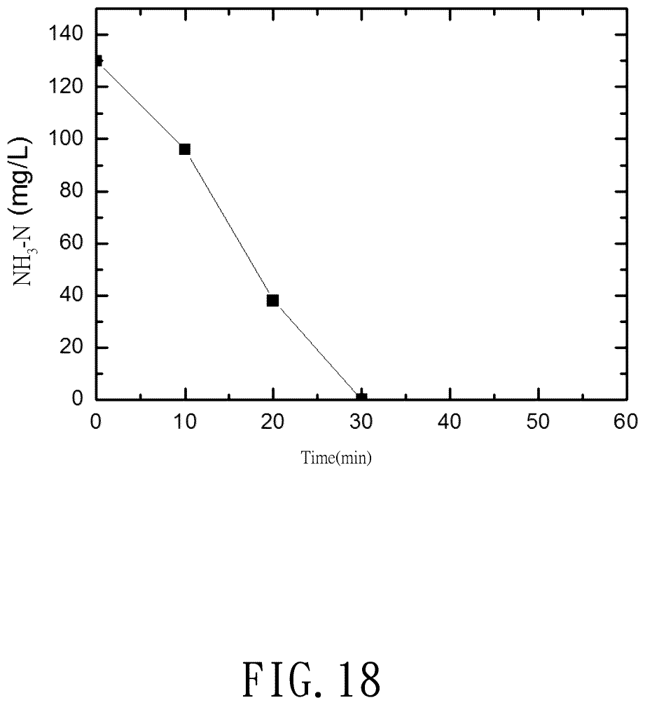

FIG. 18 illustrates the degradation of ammonia nitrogen utilizing Device 2 to perform electrolysis (4 V, 4 A) on laundry wastewater without the addition of bleach, according to an embodiment of the present invention. In order to ensure the future scalability of our ammonia nitrogen degradation experiments, we have shifted away from using commercially available equipment and have instead conducted the reactions in a 2-liter beaker. For Device 2, the material of the first electrode is, for example, DSA, and the material of the second electrode is, for example, titanium. As shown in FIG. 18, complete degradation of ammonia nitrogen requires 30 minutes.

### Example 5: Parallel Electrolysis Assisting PVA Gel Beads

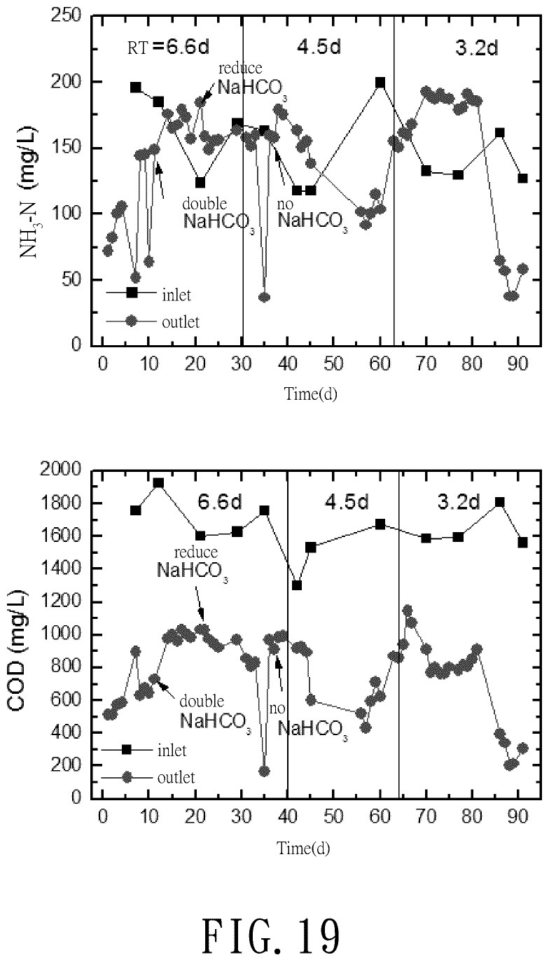

FIG. 19 illustrates the instability of COD and ammonia nitrogen degradation in a scenario where PVA gel beads without dual microbial sources are used, according to an embodiment of the present invention. The water body in this embodiment is the same as that in Example 2. The purpose of using in this embodiment is to explain that when the properties of the water body vary significantly, and if the wastewater in Example 2 (cleaning wastewater from a printing machine in a corrugated- and cardboard-packaging factory) is not subjected to biological action with PVA gel beads entrapped with dual microbial source beforehand, the actual treatment situation, such as using PVA gel beads with a single microbial source for biological action, is highly unstable. In the original batch study, treating COD to 500 mg/L required only 1-2 days. Since the amount of wastewater from the corrugated- and cardboard-packaging factory's cleaning process is only 5 CMD, longer retention time for bacterial acclimation was considered to cope with the highly variable wastewater characteristics. As shown in FIG. 19, it can be observed that the original PVA gel beads were not able to adapt within the given time frame. There was no difference in performance between retention times (RT) of 6.6 days and 3.2 days, and the data at 3.2 days were even better. While the feasibility of the electrolysis method was demonstrated in Example 2, if PVA gel beads with dual microbial source had not been used at the time, it could indeed be regulated using the electrolysis method, since the response time of electrolytic reaction is shorter.

### Example 6: Using PVA Gel Beads as an Electrolyte to Enable Direct Electrolysis of Ammonia Nitrogen to Become Feasible, Simultaneously Enhancing the Biological Action

In consideration of water bodies with non-conductive characteristics, the present invention also introduces a novel water treatment method known as “PVA Gel Bead-Assisted Energy-Driven Water Treatment Method” to replace the traditional Anammox technology. We utilized PVA gel beads during the biological treatment process and applied direct current (DC) electricity. The current treatment capacity for NH₃—N and NO₃—N is 1.12 and 12 kg-N/m3-bead-day, respectively.

(Experimental setup 1 in this scenario) In this embodiment, the energy-driven PVA gel bead device is equipped with electrodes, such as a commercially available USB electrode. The specifications include, for example, a length of 18 mm, a width of 10 mm, and a thickness of 0.7 mm, with a gap of, for example, 1 mm between the electrodes. The second electrode is, for example, made of titanium, while the first electrode, for example, utilizes DSA. The reactor used in this embodiment is, for example, a 500-milliliter serum bottle, filled with 10% (w/v) PVA gel beads (also known as Vita Beads). If there are concerns about chloride ions in the water body, activated carbon can be added to remove the hypochlorous acid produced during the electrolysis process. In practical applications, trace amounts of hypochlorous acid can be utilized to oxidize ammonia nitrogen without harming the microorganisms within the PVA gel beads.

(Experimental setup 2 in this scenario) In this embodiment, the electrodes used are, for example, custom-made laboratory electrodes with a width of 30 mm, a length of 100 mm, a thickness of 2 mm, and a gap of 1.1 mm. The second electrode is, for example, made of titanium, while the first electrode, for example, utilizes DSA. The reactor employed in this embodiment is, for example, an 8-liter fish tank, filled with 1.5 liters of PVA gel beads and 80 grams of activated carbon.

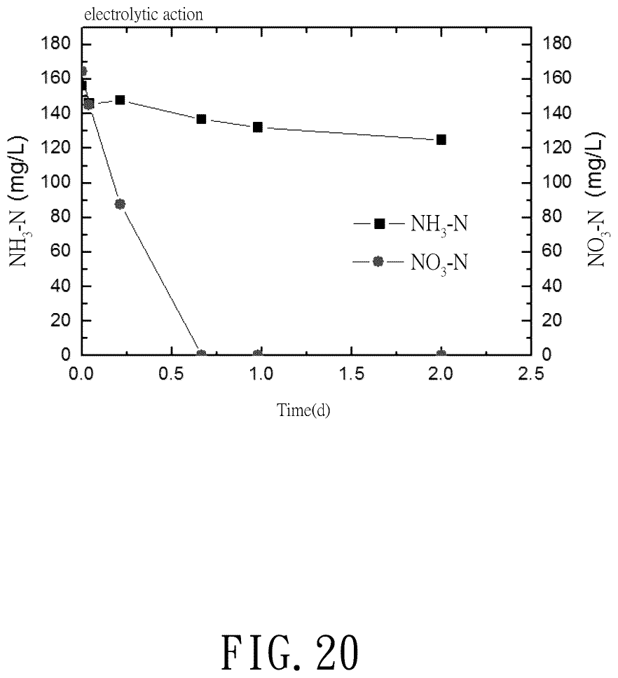

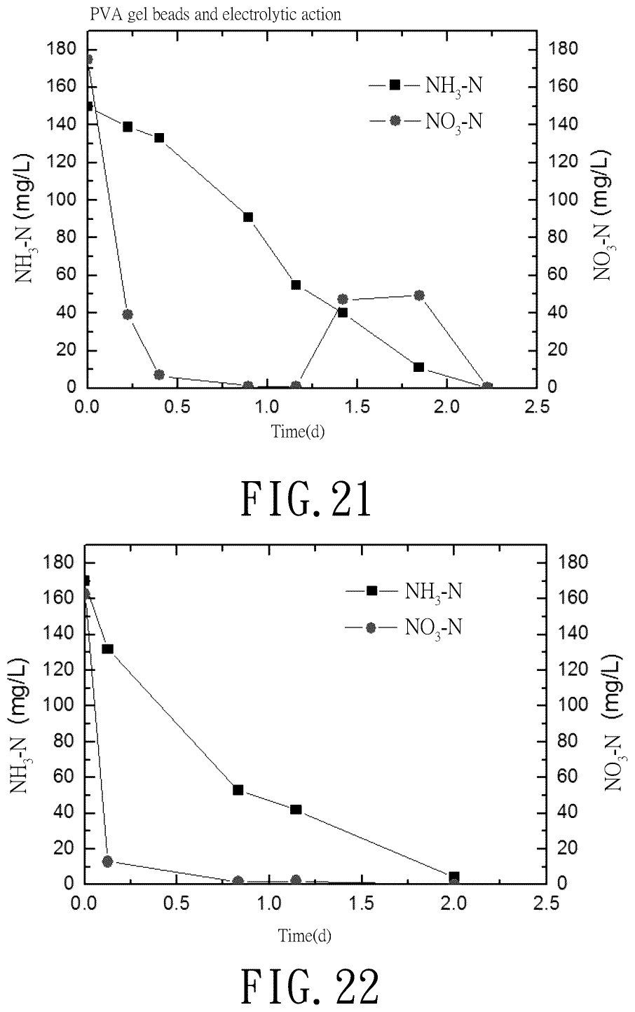

Please refer back to FIG. 2C. FIG. 2C depicts a schematic diagram of the reactor configuration used in this embodiment of the invention, illustrating a single-tank internal circulation reactor (Continuous Stirred-Tank Reactor, CSTR). The internal circulation reactor, for example, involves directly inserting the electrodes into the water within the reactor. This direct insertion eliminates the need for an additional water pump, contributing to energy savings. FIG. 2D is a schematic diagram of a reactor configuration used in another embodiment of the present invention, illustrating a single-tank external circulation reactor (Continuous Stirred-Tank Reactor, CSTR). Please refer to FIG. 2D. In this external circulation reactor, the primary reactor, for example, contains PVA gel beads 110. The electrolysis device 120 is, for example, positioned at the outlet of the reactor. After undergoing electrolysis, a portion of the effluent water is recirculated back to the main reactor through external circulation. Within this external circulation method, activated carbon (AC) can be utilized to remove residual hypochlorous acid, thereby minimizing their impact on the microorganisms. (Low Chloride Content Water Body Experiment Setup) The water body in this embodiment is the same as that in Example 1. The chemical oxygen demand (COD) of the aforementioned water body has been reduced to less than 400 mg/L, but the ammonia nitrogen and nitrate nitrogen levels are approximately 200 mg/L each. In this embodiment, a 500-mL serum bottle is, for example, used. A USB electrode is inserted into the serum bottle, and a microcurrent of 5 watts (5 volts, 1 ampere) is applied. FIG. 20 illustrates a series of experiments for the development of energized PVA gel beads conducted in a low-salinity water body with only electrolysis being carried out in this experiment as a comparison, according to an embodiment of the present invention. FIG. 21 illustrates an embodiment of the present invention in a series of experiments for the development of energized PVA gel beads, using PVA gel beads in a low-salinity water body with intermittent electrolysis (15-minute suspension every two hours). FIG. 22 illustrates an embodiment of the present invention in a series of experiments for the development of energized PVA gel beads, using PVA gel beads in a low-salinity water body with continuous electrolysis throughout the duration. From FIG. 20, it can be observed that under low-salinity conditions, ammonia nitrogen is not oxidized by electrolysis, while nitrate nitrogen can be electrolytically oxidized under the appropriate electrode. FIGS. 21 and 22 show that when 10% PVA gel beads are introduced into the aforementioned reactor and subjected to electrolytic action, the degradation rates of ammonia nitrogen and nitrate nitrogen are better in the case of PVA gel beads undergoing biological action and electrolysis than in the case of electrolysis alone. On the second day (as shown in FIG. 20), if PVA gel beads are not introduced, the ammonia nitrogen concentration remains around 130 mg/L. However, when PVA gel beads are introduced (as shown in FIG. 22), the ammonia nitrogen concentration approaches zero. Similarly, for nitrate nitrogen comparison, at the 6th hour (as shown in FIG. 20), if PVA gel beads are not introduced, the nitrate nitrogen concentration is 90 mg/L. But with the introduction of PVA gel beads (as shown in FIG. 21), the nitrate nitrogen concentration is 40 mg/L.

For the embodiments involving the introduction of PVA gel beads, a continuous microcurrent (as shown in FIG. 22) is, for example, preferred over intermittent microcurrent (as shown in FIG. 21). Intermittent microcurrent can be controlled using a time relay, for example, by pausing electrolysis for 15 minutes every two hours. The results indicate that a continuous microcurrent is more effective than an intermittent microcurrent. As shown in FIG. 21, the nitrate nitrogen concentration is 40 mg/L at the 6th hour, while in FIG. 22, nitrate nitrogen is reduced to 0 mg/L. Regarding ammonia nitrogen, as shown in FIG. 21, it is 90 mg/L at 0.8 days, whereas in FIG. 22, it is lowered to 50 mg/L.

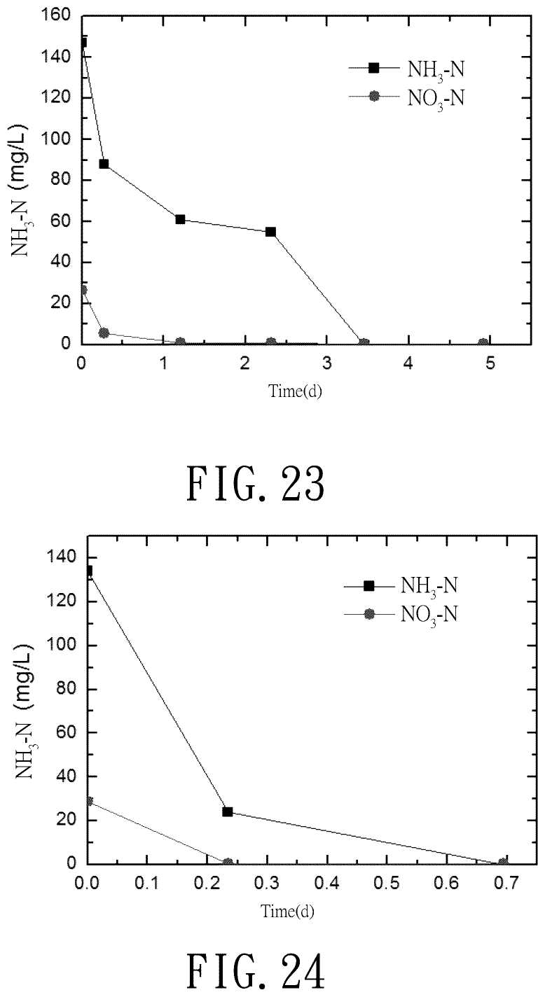

(High Chloride Content Water Body Experiment Setup) FIG. 23 illustrates the changes in ammonia nitrogen and nitrate nitrogen during intermittent electrolysis experiments (15-minute suspension every two hours) using PVA gel beads with Device 1 in a high-salinity water body, according to an embodiment of the present invention. The experiment is a continuation of using Device 1 with USB-connected electrodes for energy quantification. At the beginning, there is a rapid decrease in ammonia nitrogen, possibly due to the electrolysis effect. However, the rate of reduction slows down over time. Upon inspection, it was discovered that the electrodes were blocked by precipitates of magnesium hydroxide, leading to increased resistance and decreased current, resulting in operational failure. After addressing this issue and eliminating the blockage, the degradation of ammonia nitrogen accelerated. The total experiment duration was longer than the case of water body with low chloride. This raises the suspicion that hypochlorous acid generated during electrolysis might have caused bacterial death. However, after an adaptation period, repeated experiments demonstrated that PVA gel beads completely degraded the remaining 50 mg/L of ammonia nitrogen in less than 5 hours. As for nitrate nitrogen, its degradation capability remained consistently superior and was achieved rapidly throughout the experiment.

Subsequently, energy-driven experiments were conducted using the self-made Device 2 in the laboratory, and the results are shown in FIG. 24. FIG. 24 illustrates an embodiment of the present invention in a series of experiments for the development of energized PVA gel beads, using PVA gel beads in a high-salinity water body with continuous electrolysis throughout the duration. Both ammonia nitrogen and nitrate nitrogen degraded rapidly. Compared to the embodiment shown in FIG. 23, the embodiment in FIG. 24 might show different results due to the utilization of different equipment and the different ratio between water volume and an electrode plate area. In this experiment, the ratio of water volume to the electrode plate area was 140 cm, and the current density was 8 mA/cm². However, based on previous experimental results, the degradation of ammonia nitrogen under electrolysis without PVA gel beads could potentially be completed within 40 minutes. Therefore, we conclude that the energy-driven PVA gel beads technology may not be necessary for use in high-salinity water body.

The water treatment method presented in this embodiment of the present invention involves the addition of multiple PVA gel beads to the water body, so as to enable the water body to carry out a biological action, and applying electrolysis through an electrolysis device. This enables the treatment of nitrogen-containing substances in water body without the need for additional carbon sources. Furthermore, it enhances the removal efficiency of organic matter or nitrogen-containing substances in the water body. For instance, this embodiment of the invention can achieve complete decomposition of 1,750 mg/L NO₃—N, and the stability of microbial activity within PVA gel beads is maintained during biological action. Moreover, the water treatment method of this embodiment of the present invention can be conducted at room temperature, thus offering the advantage of reduced carbon emissions.

### LITERATURE REVIEW

1. Cho S., Kambey C., Nguyen V. K., Review: Performance of Anammox Processes for Wastewater Treatment: A Critical Review on Effects of Operational Conditions and Environmental Stresses. Water. 12(1):20, 2020.
2. DONGLEI WU, LILI WU, YANZHANG LUO, QINHAI HU, Electrolytic-biological anaerobic reactor and technique thereof, China Patent document CN 101693577 A (2010).
3. KUNPING WANG, JINSONG GUO, SHAOJIE JIANG, TAO WANG, Method for removing nitrates from water, China Patent document CN 101704595 A (2010).
4. CHUANPING FENG, MIAO LI, Sewage nitrate-removing device using electrochemical method, China Patent document CN 202576056 U (2012).
5. Deng, S., Li, D., Yang, X., Xing, W., Li, J., Zhang, Q., Biological denitrification process based on the Fe(0)-carbon micro-electrolysis for simultaneous ammonia and nitrate removal from low organic carbon water under a microaerobic condition. Bioresource Technology. 219: 677-686, 2016.
6. Chen, K.-C. and Lin, Y.-F., Immobilization of microorganisms or enzymes in polyvinyl alcohol beads. U.S. Pat. No. 5,290,693, 1994.
7. Kuraray Co., Ltd., Shaped article made of porous hydrogel, method for producing the same and use thereof. TW 201332640 A1, 2012.
8. Aslam, M., Kalyar, M. A., Raza, Z. A., Polyvinyl Alcohol: A Review of Research Status and Use of Polyvinyl Alcohol Based Nanocomposites. Polymer Engineering and Science. 58:2119-2132, 2018.
9. Dinh, P. V. and Bach, L. T., Immobilized bacteria by using PVA (Polyvinyl alcohol) crosslinked with Sodium sulfate. International Journal of Science and Engineering, 7(1): 41-47, 2014.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the scope of protection of the present invention shall be determined by the scope of the patent application attached hereto.

What is claimed is:

1. A water treatment method, suitable for water treatment of a water body containing a nitrogen-containing substance, wherein the water treatment method comprises:
adding multiple PVA gel beads to the water body, wherein each of the PVA gel beads entraps at least one type of microorganism, so that the water body is subjected to a biological action; and
the water body is subjected to electrolysis with an electrolysis device.

2. The water treatment method according to claim 1, wherein the at least one type of microorganism comprises autotrophic nitrifying bacteria, heterotrophic nitrifying bacteria, yeast, microorganisms suitable for degrading organic matter, algae or a combination thereof.

3. The water treatment method according to claim 1, wherein the water body is first subjected to the biological action, and then the water body is subjected to the electrolysis.

4. The water treatment method according to claim 3, wherein after water body is subjected to the biological action and before the electrolysis, at least one salt is added, and the at least one salt is a halogen-containing compound.

5. The water treatment method according to claim 4, wherein the at least one salt comprises sodium chloride, potassium chloride, calcium chloride, magnesium chloride or a combination thereof.

6. The water treatment method according to claim 1, wherein the water body further has a halogen-containing substance, and after the water body is subjected to the electrolysis, the PVA gel beads are added to the water body to perform the biological action.

7. The water treatment method according to claim 1, wherein the electrolysis and the biological action are performed simultaneously.

8. The water treatment method according to claim 1, wherein the operating voltage of the electrolysis device is between 5 V and 100 V, and the operating current of the electrolysis device is between 1 A and 1000 A.

9. The water treatment method according to claim 1, wherein the operating voltage of the electrolysis device is between 5 V and 60 V, and the operating current of the electrolysis device is between 10 A and 300 A.

10. The water treatment method according to claim 1, wherein the electrolysis device operates at a current density between 5 mA/cm² and 100 mA/cm².

11. The water treatment method according to claim 1, wherein the electrolysis device operates at a current density between 20 mA/cm² and 30 mA/cm².

12. The water treatment method according to claim 1, wherein the operating temperature of the electrolysis device is between room temperature and 50° C.

13. The water treatment method according to claim 1, wherein the electrolysis device performs the electrolysis on the water body with a constant voltage or a constant current.

14. The water treatment method according to claim 1, wherein the electrolysis device comprises a first electrode and a second electrode, and the first electrode and the second electrode are connected or separated from each other by a distance.

15. The water treatment method according to claim 14, wherein the distance is between 2 mm and 50 mm.

16. The water treatment method according to claim 14, wherein the distance is between 2 mm and 20 mm.

17. The water treatment method according to claim 14, wherein the first electrode is a DSA electrode, and the second electrode is a DSA electrode or a titanium electrode.

18. The water treatment method according to claim 17, wherein the DSA electrode comprises a base layer, an intermediate layer and a surface layer, the intermediate layer covers the base layer, and the surface layer covers the intermediate layer, wherein a material of the base layer comprises titanium, a material of the intermediate layer comprises iridium, tin or a combination thereof, and a material of the surface layer comprises ruthenium.
